(19) United States
(12) Patent Application Publication
(10) Pub. No.: US 2005/0184471 A1
(43) Pub. Date: Aug. 25, 2005

(54) Water-closet compound gasket

(76) Inventor: Gabriel Omar Ponce, Florida - Buenos Aires (AR)

Correspondence Address: ABELMAN, FRAYNE & SCHWAB, 666 THIRD AVENUE, 10TH FLOOR, NEW YORK, NY, 10017, US

(21) Appl. No.: 11/019,342

(22) Filed: Dec. 21, 2004

Related U.S. Application Data
(63) Continuation-in-part of application No. 10/251,363, filed on Sep. 18, 2002, now abandoned.

(30) Foreign Application Priority Data
Sep. 19, 2001 (AR) P01-01-04432
Sep. 13, 2002 (AR) P02-01-03486

(51) Int. Cl. F16L 17/00

(52) U.S. Cl. 277/603

(57) ABSTRACT

A one-piece water-closet gasket (21) comprises an outer gasket (39) for the stand (41) and an inner gasket (43) for sealing the outlet of the water-closet drain-duct (29) to the sewage inlet duct (37). The latter gasket comprises a tube (51) having a lower span (53) for plugging into the sewage inlet and is provided with means (55, 57) elastically bearing and sealing against the inner wall surface of the sewage duct.

### CROSS-REFERENCE TO RELATED APPLICATION

The present patent application is a divisional/continuation-in-part of my now-abandoned U.S. patent application Ser. No. 10/251,363. It is requested that my parent application Ser. No. 10/251,363 be incorporated by reference into and as a part of this present Continuation-in-Part application.

### FIELD OF THE INVENTION

A water-closet (“w.c.”, “toilette” or “loo”) comprises a bowl made of glassed porcelain or the like having a pan formed therein for collecting faeces, urine and like human exudates. The top of the pan is connected to the end of a water pipe for flushing the pan and carrying away the substances deposited therein. A drain pipe leads off from the bottom of the pan and through a syphon or hydraulic trap down to an outlet opening at the bottom of the bowl such that, when the water-closet is installed, the outlet opening faces down into the inlet hole of a sewage drain-pipe in the floor of the bathroom.

The present invention concerns a gasket for sealing the connection between the drain-pipe of the water-closet and the sewage drain-pipe in the floor for pre-venting water and the bodily wastes from leaking out and soiling the floor, thereby assisting in bathroom upkeep and hygiene. Of course, the gasket may find other applications in similar sanitary fixtures, such as bidets and urinals, having drainage means passing through the floor or like building surface.

### BRIEF REVIEW OF THE PRIOR ART

To install a water-closet on the bathroom floor is not a difficult task. The bowl is placed directly on the floor to which it is anchored by a set of bolts, such that the drain-pipe is located right on top of the sewer pipe inlet at floor level. Sealing is carried out to prevent soiling of the floor around the water-closet by means of a rubber gasket the top end of which is affixed to the drain duct and its bottom end rests resiliently against the floor.

This bottom end of a conventional gasket may include three concentric rings the free circumferential edges of which bear against the floor to prevent passage of fluid and wastes outwards.

The conventional sealing means are prone to irregularities on the floor surface, which one generally tries to overcome by adding some sealer material to make up for the unevenness of the floor. However, the material eventually loses its sealing properties with time as the material ages and because of micromovements which happen in the course of normal use of the water-closet, among other reasons.

U.S. Pat. No. 2,976,543 discloses a water-closet gasket having an upper disk for sealing the water-closet's drain-hole against the floor and a tubular seal featuring external resilient circumferential rings sealing against the wall of the sewer pipe on the bathroom floor. This gasket only prevents soiled liquid that is being flushed down the drain connection from spilling out onto the floor but does not prevent liquid on the floor from seeping under the closet stand, such as when the floor is washed.

Commonly assigned U.S. Pat. No. 6,644,670 discloses an outer gasket section for sealing the water-closet stand against the surface of the bathroom floor. The embodiment of FIG. 9 integrates the aforementioned oblong outer gasket section with an annular inner sealing section for simultaneously sealing the supporting edge of the water-closet stand against the floor and the connection of the drain outlet to the sewer line. The inner sealing section is a vent-type socket including a cylindrical, corrugated wall. Integrated hinged longitudinal and traverse web members connect the inner and outer sections to each other.

### SUMMARY OF THE INVENTION

An object of the invention is to provide a gasket for sealing the outlet of water-closet so as to assure a leak-free connection, independently of the surface condition of the floor, to avoid sewage odours and leakage of liquids from the drain duct.

Another object is to provide a gasket which makes sanitary fixtures easy, quicker and cheaper to install, adaptable furthermore to different sewer piping sizes.

An further object of the invention is to provide a compound gasket for improving the bearing and securement of the fixture of the floor and including the sealer gasket of the water-closet drain for assuring good sealing of the bearing, blocking water coming from washing down the bathroom floor from leaking into the compartment formed under the stand of the bowl and stopping dirt from getting inside and into the gap between the fixture and the floor.

To attain these and other objects and advantages which may become apparent in the course of this description, the gasket for sealing the water-closet drain includes a tube the top of which is affixed to the drain-pipe of the water-closet. The tube includes a lower span fitting into the sewage pipe and provided with rings or like sealing means on the outer surface thereof for forming a fluid-tight seal against the inner surface of the sewage-pipe. According to the invention, the drainage gasket is integrated into a common one-piece compound gasket which includes an oval gasket portion through which the base of the water-closet stand rests on the floor.

In a preferred embodiment, the gasket is a single piece of moulded plastics material, such as polyvinyl, rubber or the like, integrating gasket sealing rings consisting of several rings longitudinally separated along the part of the single piece forming the tube of the gasket. In alternative embodiments, tubular bellows may be used, for instance, in place of the rings. As an accesory, the one-piece gasket may further include the conventional concentric rings as well as inner sealer means about the top end of the gasket tube for fitting onto and forming a tight seal about the hole of the drain-pipe of the water-closet.

### BRIEF DESCRIPTION OF THE DRAWINGS

FIG. 1 is a schematic perspective view of the drain piping of a water-closet which is shown transparented for purposes of illustration wherein the present invention finds application.

FIG. 2 is a perspective view of a one-piece compound gasket for a water-closet including the drainage sealer gasket part according to a preferred embodiment of the present invention.

FIG. 3 is a front-back elevation view of the gasket of FIG. 2.

FIG. 4 is a cross-section view of the gasket of FIG. 2.

FIG. 5 is a schematic perspective underside view of the water-closet stand of FIG. 1 showing the installation of the gasket of FIGS. 2 to 4.

FIGS. 6 a 12 are cross-sections analogous to that of FIG. 4 illustrating different drainage sealer gaskets parts according to respective alternative embodiments of the present invention.

FIG. 13 is a cross-section view of an inner sealer gasket part according to a further embodiment of the invention.

### PREFERRED EMBODIMENTS OF THE INVENTION

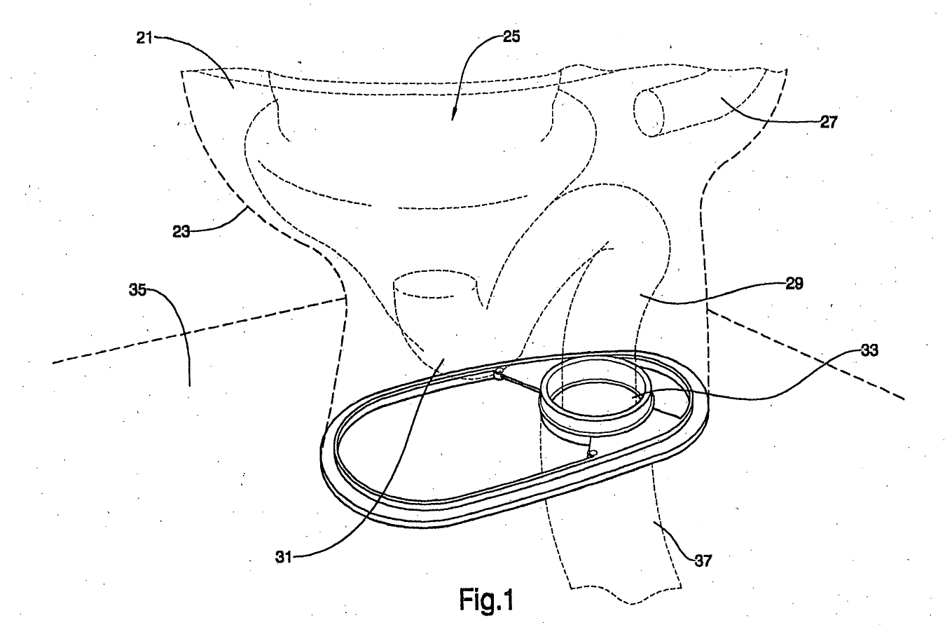

A field of application of the gasket of the present invention for sealing the drain-outlet of water-closets 21 is disclosed, notwithstanding persons skilled in the art may adapt it to other uses. As illustrated in FIG. 1, the water-closet 21 comprises a bowl 23 of ceramic glass in the form of a pan 25 having an inside for receiving human wastes or exudates. A duct 27 allows water to be flushed into the pan 25 for evacuating the latter through a drain-duct 29. This drain-duct 29 conventionally includes a syphon 31 for trapping water in the pan 25 and sealing malodours in a sewage pipe 37 from emanating from the pan 25 to the bathroom.

Refering specifically to the application of the present invention, the sewage-pipe 37 has a hole at floor level 33 over which the water-closet 25 is installed such that it may be engaged by the outlet hole 33 of the W.C. drain-duct 29, using a compound gasket described in the following exemplary embodiments to prevent soiled fluid from leaking through the connection and soiling the surface of the floor 35.

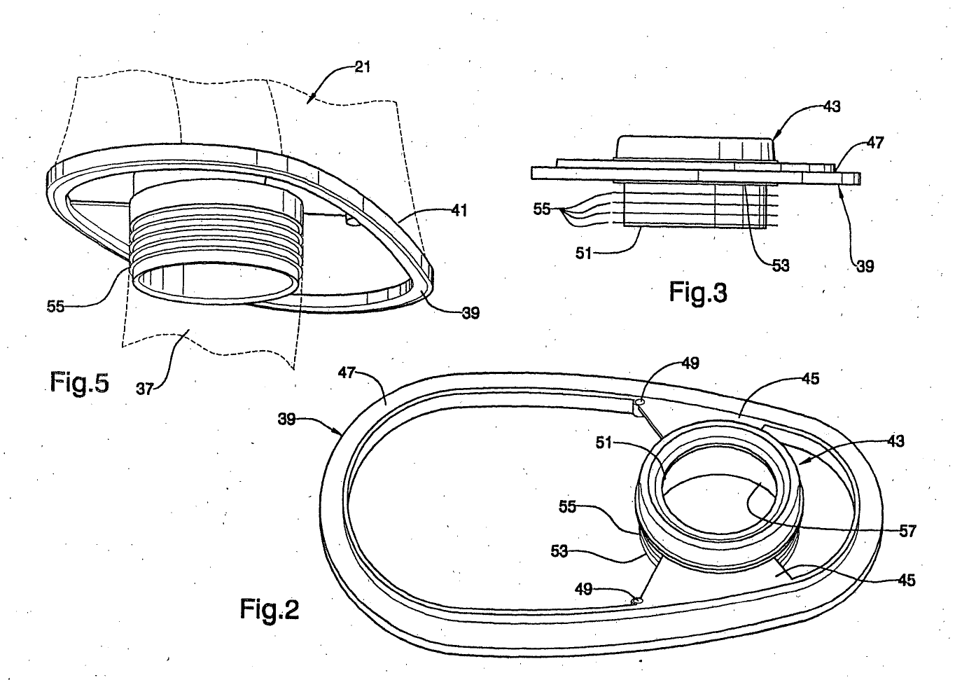

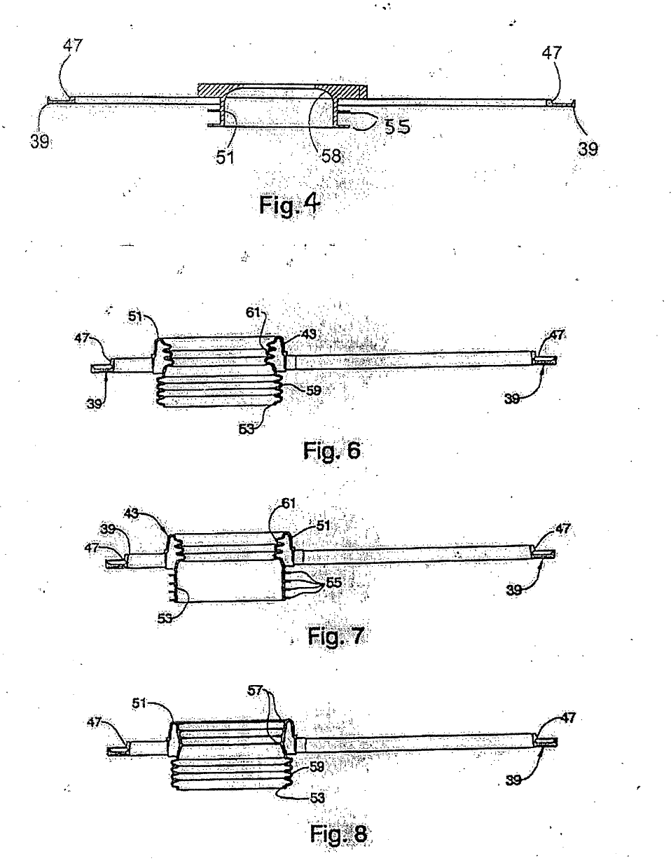

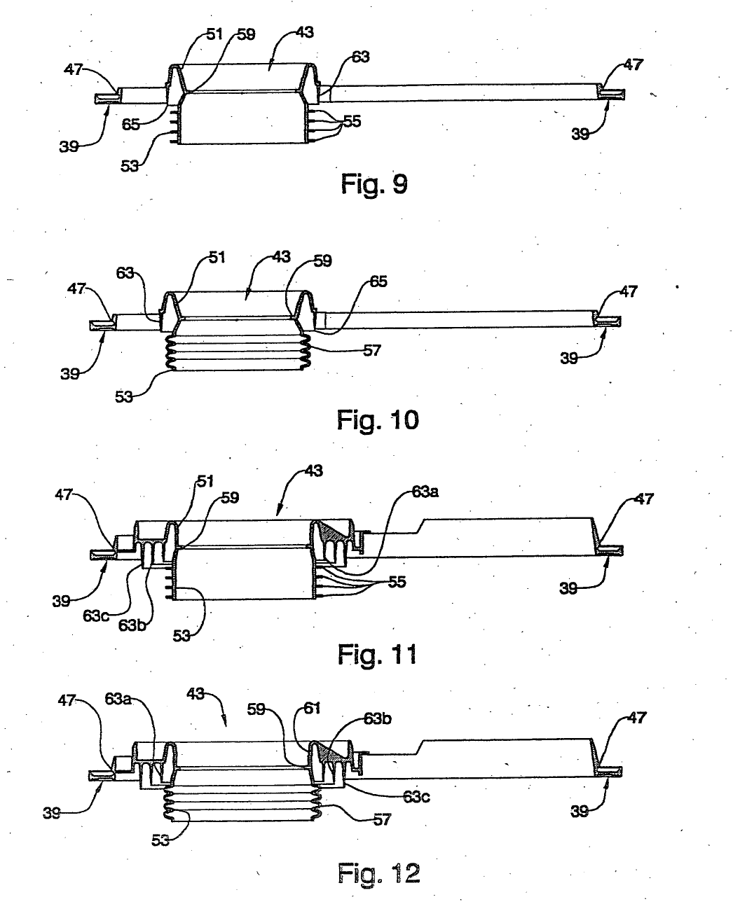

FIGS. 2, 3 and 4 illustrate in detail a preferred embodiment of a compound gasket for water-closets 21, comprising a gasket outer portion 39 having an ovaloid shape like the perimeter of the base of the stand 41 (FIG. 5), on which the bowl 23 rests or bears on the floor 35 (FIG. 1), an inner portion 43 forming the drainage sealer gasket part and a pair of radial spokes 45 bridging both gasket portions 39 and 43 to form a single piece of moulded plastics material, such as polyvinyl, rubber or like material providing slightly resilient properties, with the aggregation of anti-microbic agents. The external gasket 39 is moulded with a small step 47 on its upper face so as to fit into the base of the stand 41. The spokes 45 are pierced by a pair of orifices 49 through which bolts for securing the bowl 23 to the floor 35 may be passed.

The water-closet drainage sealer gasket 43 comprises a tube 51 of the same slightly resilient moulded plastics material which joins the drain 33 hole at the bottom of the water-closet 21 to the sewage-pipe 37. Specifically, the upper end of the tube 51 is affixed to the drain-duct 29 whereas at its bottom end, the tube 51 extends into a span 53 which plugs into the sewage-pipe 37, thereby providing the necessary connection in the water-closet 21 installation.

To improve and assure the sealability of this connection, sealer rings made of the same moulded plastics material, e.g. four longitudinally-spaced flat rings 55, are integrated onto the outer wall surface of the bottom tubular span 53. The seal-tight connection is achieved by the resilient pressure of the rings 55 against the inner wall surface of the pipe 37.

Carrying out the sanitary connection is easy to learn and do. The upper end 51 of the tube is fitted onto the end of the hole 33 at the end of the water-closet pipe 29. The outer gasket part 39 is fitted onto the perimeter of the base of the stand 41 before bringing the bowl 23 to rest on the floor 35 and effortlessly shoving the tubular ringed span 53 down sufficiently inside the pipe 37. Thereby securing bolts are installed through the orificies 49 in the spokes 45. FIG. 5 illustrates the final installation of the water-closet bowl 23 with the gasket.

Considering FIGS. 2, 3 and 4 again, the top end of the tube 51 may be connected in different ways to the drain duct 29. For instance, the top end of the tube 51 may terminate in the shape of a cup 58 to sealingly adapt to toilets of different sizes and shapes. The present invention also suggests doing it by plugging the hole 33 of the duct 29 inside the upper end of the tube 51, the inner wall surface of which has concave form in your superiors corners 58 what you allow to place any type of toilet adapting to this internal wall.

FIG. 6 illustrates a variant to the main seal-rings, consisting in forming the bottom span 53 as a bellows 59. The bellows 59 have the same purpose of the sealer means 53 of the preceding embodiment in that, when they are forced into the pipe 37, the exert an expansion pressure against the inner wall surface of the sewage pipe 37. In the same way, the additional sealer means may be formed by a bellows 61 in the upper end of the tube arranged to exert resilient pressure about the hold 33 of the drain duct 29.

FIGS. 7 and 8 illustrate other alternative embodiment which have are foreseen although believed to be not as preferable as the preceding embodiments, consisting in different combinations of the seal-rings 55 y 57 of FIG. 5 alternated with the bellows 59 and 61 of FIG. 7.

The cross-sections shown in FIGS. 9 and 10 illustrate further alternative embodiments of the drain gasket portion for the compound gasket of the invention wherein an upstanding ring 63 concentric relative to the tube 51 is integrated into the one-piece compound gasket of the invention. The upstanding ring 63 has at the bottom thereof a free circumferential edge 65 which bears on the floor 35, as in some conventional gaskets. The cross-sections shown in FIGS. 11 and 12 are respectively similar to the embodiments of FIGS. 9 and 10 except that three concentric rings 63A, 63B and 63C are integrated into the one-piece gasket to seal against the floor surface 35.

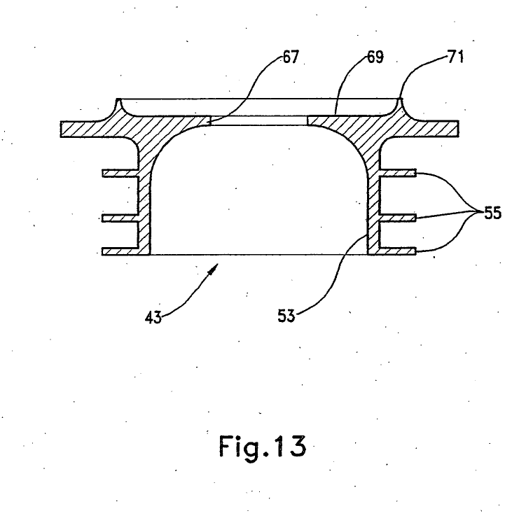

FIG. 13 is a cross-section of a further embodiment of a drain sealer gasket part 49 which, as in the other embodiments, may be integrated into a single piece with the stand gasket part 39. The upper portion of the gasket 49 depicted in FIG. 13 is an integrated disk 67 featuring a generally flat face 69 except for an upstanding ring-shaped ridge 71 designed to fit around the outer edge 33 of the bowl drain-duct 29. Installation is simplified in this case since there is no need to first fit the gasket 43 about the drain outlet pipe 29.

The lower portion of the gasket 43 has three flat rings 55. The gasket 43 is installed and works essentially in the same way as the the other embodiments, sealing the drain connection once the bowl 23 is placed thereon and secured to the floor 35.

Of course, changes, variations and aggregations may be made to the multiple embodiment describe above, without departing from the scope nor the spirit of the invention. The same has been described by way of preferred embodiments specifically for water-closets, however those skilled in the art may suit it to other applications without departing from the purview of the invention as set forth in the appended claims. For example, the inner gasket 43 may be independent or devoid of the outer gasket 39 or the four rings 57 or the bellows 61 near the upper end of the tube 51 be increased, reduced or omitted for practical reasons, if any, among other variations.

1. For a sanitary fixture which is installed to a building surface having a drain inlet hole therein, said fixture having a stand with a drain outlet terminating in a hole for placement over and opposite said building hole when said fixture is installed thereon for thereby connecting said fixture hole to said drain inlet hole located in said building; said drain inlet hole surrounded by a wall surface; a gasket for sealing the connection between said fixture hole and said building hole, said gasket comprising:
an outer gasket part having a shape generally adapted to the perimeter of the fixture stand,
an inner gasket part for sealing the connection between said drain outlet hole and said building inlet hole, and
at least two radially-spaced spoke means bridging said outer and inner gasket parts, thereby integrating both said gasket parts into a single piece of slightly resilient material;
wherein said inner gasket part comprises:
an upper portion for engaging said stand outlet hole and
a tubular span extending downwardly from said upper portion for insertion into said building inlet hole; said tubular span having an outer surface provided with deformable sealer ring means for resiliently sealing against said building inlet wall surface.

2. A gasket according to claim 1, wherein said sealer ring means comprise at least one external sealer ring integrated with the tubular span into a single piece of slightly-resilient material.

3. A gasket according to claim 1, wherein said sealer ring means comprise a plurality of sealer rings longitudinally spaced along said outer surface of the tubular span of the gasket.

4. A gasket according to claim 3, wherein said plurality of sealer rings comprises between three and four rings.

5. A gasket according to claim 3, wherein said sealer rings are integrated with the tubular span into a single piece of slightly-resilient material.

6. A gasket according to claim 3, wherein said tubular span includes bellows means elastically expandible against the wall surface surrounding the building inlet hole.

7. A gasket according to claim 1, wherein said tubular span is surrounded by concentric downwardly-depending rings spaced outwardly therefrom and provided with free lower ends for bearing on said building surface.

8. A gasket according to claim 1, wherein said gasket upper portion comprises a generally flat disk integrated to said tubular span.

9. A gasket according to claim 8, wherein said disk has a generally flat upper face for abutment of said fixtrue hole and surrounded by an upstanding ring-shaped ridge adapted to fit around said fixture hole.

10. A gasket according to claim 1, wherein said gasket upper portion comprises an upper tubular span provided with at least one internal substantially-resilient sealer ring arranged about the inner surface thereof and integrated with the upper tubular span into a single piece of slightly-resilient material.

11. A gasket according to claim 10, wherein said upper tubular span has an inner surface into which said fixture drain outlet plugs into and said at least one internal sealer ring comprises a plurality of rings longitudinally spaced along said inner surface of the upper tubular span.

12. A gasket according to claim 10, wherein the fixture drain outlet has an outer wall surface and said upper tubular span provided with at least one internal sealer ring comprises a bellows into which said fixture drain outlet plugs into and which is elastically expandible against said wall surface of the fixture drain outlet.

13. A gasket according to claim 1, wherein said spoke means two integrated spokes radially extending in diametrically opposite directions from said inner gasket part.

14. A gasket according to claim 1, wherein said building surface is a floor.

15. A gasket according to claim 13, wherein said sanitary fixture is a water-closet.
